(19) United States
(12) Patent Application Publication
(10) Pub. No.: US 2005/0215453 A1
(43) Pub. Date: Sep. 29, 2005

(54) Composition comprising a mixture of alkylmono and polylactyllactate

(76) Inventor: Remy Teissier, Francheville (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/510,929

(22) PCT Filed: Mar. 17, 2003
(86) PCT No.: PCT/FR03/00843

§ 371 Date: May 16, 2005

(30) Foreign Application Priority Data
Apr. 12, 2002 (FR) 02/04591

(51) Int. Cl. C11D 17/00

(52) U.S. Cl. 510/421

(57) ABSTRACT

The present invention relates to an oligomeric composition of lactic acid ester comprising a mixture of monoalkyl and polyalkyl lactyllactates which are useful alone or in combination with other solvents for cleaning and degreasing. The lactyllactates have a high flash point, low toxicity, low odor and do not release volatile organic compounds in use.

The present invention relates to an oligomeric composition of lactic acid esters comprising a mixture of monoalkyl and polyalkyl lactyllactates of formula:
CH₃CH(OH)[C(O)OCH(CH₃)]ₙ₋₁CO₂R (I)
in which R represents an alkyl radical containing a number of carbon atoms ranging from 1 to 4 and n is an integer equal to 2, 3 or 4.

The invention relates most particularly to a composition of monoethyl and polyethyl lactyllactates.

This composition may be used alone or in combination with other solvents, especially as agents for cleaning and degreasing, in a machine and in non-aqueous medium, of solid surfaces such as metallic components, ceramics, glass and plastics that have been soiled and/or temporarily protected with machine oils or greases. They may also be used for defluxing printed circuits, this defluxing operation consisting in removing the welding flux.

Besides the solvent power, the cleaning and/or degreasing agents should have other characteristics and especially, for instance, they should have a high flash point, low toxicity, should be odorless and should not release volatile organic compounds (VOCs) into the atmosphere.

The composition of the present invention globally satisfies the criteria mentioned above.

In particular, it has no odor, it has a high flash point (>100° C.), a high boiling point and a low vapor pressure. In addition, it is biodegradable and non-toxic.

The composition of the present invention may also be used to obtain lactides—cyclic dimers—which are precursors of choice for obtaining polylactides used as biomaterials.

To our knowledge, the production of the composition of the present invention has not been described in the prior art.

H. V. Claborn (U.S. Pat. No. 2,371,281) describes a process for obtaining alkyl lactyllactate by reacting lactide (3,6-dimethyl-1,4-dioxane-2,5-dione) with an alcohol R¹OH according to the reaction:

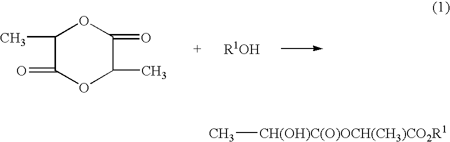

Thus, ethyl lactyllactate is obtained in a yield of 82% by reacting 0.5 mol of dry lactide with an excess of anhydrous ethyl alcohol, in the presence of benzenesulfonic acid as catalyst, at 70° C. for 6 hours 30 minutes. After removal of the excess alcohol, the reaction medium is subjected to fractional distillation under reduced pressure.

The main fraction (78 g) identified as being ethyl lactyllactate is a slightly viscous, colorless and odorless liquid and distils at 110° C.-113° C. at 7.5 mmHg.

C. E. Rehberg and M. B. Dixon (Journal Amer. Chem. Soc., 74, page 1609, 1952), who give the physical properties of several alkyl (methyl, ethyl, n-propyl, n-butyl, n-hexyl and n-octyl) lactyllactates, mention that these compounds can be obtained according to the method of H. V. Claborn mentioned above (U.S. Pat. No. 2,371,281) or that these compounds are by-products in the preparation of simple alkyl lactates at the laboratory stage, the conversion into alkyl lactyllactate usually being of about 5% to 20% depending on the alcohol/lactic acid ratio used during the esterification of said lactic acid.

These same authors also report (Journal Amer. Chem. Soc., 72, page 5759, 1950) that these alkyl lactyllactates may be obtained by transesterification of alkyl lactate in the presence of H₂SO₄.

All these methods make it possible to obtain an alkyl lactyllactate (formula I, n=2) according to laboratory methods that consist in extracting said alkyl lactyllactate by distillation (fractional) at low pressure from various reaction media.

Working in this manner is difficult to transpose to the industrial stage due to the low pressures required to obtain said alkyl lactyllactates and the use of higher pressures would run the risk of entailing decompositions and/or side reactions.

One subject of the present invention is thus a composition comprising a mixture of monoalkyl and poly-alkyl lactyllactates of formula:
CH₃CH(OH)[C(O)OCH(CH₃)]ₙ₁CO₂R (I)
in which R represents an alkyl radical containing a number of carbon atoms ranging from 1 to 4 and n is an integer equal to 2, 3 or 4.

Preferably, the alkyl radical is a methyl, ethyl, propyl, isopropyl or n-butyl radical. Most particularly, the alkyl radical is an ethyl radical.

The composition according to the invention may comprise:
35 to 85 parts by weight of alkyl lactyllactate (n=2 in formula (I)), AL₂ below;
10 to 60 parts by weight of alkyl dilactyllactate (n=3 in formula (I)), AL₃ below; and
1 to 20 parts by weight of alkyl trilactyllactate (n=4 in formula (I)), AL₄ below; AL₂+AL₃+AL₄ representing 100 parts by weight.

The composition according to the invention may also contain an alkyl lactate of formula CH₃CH(OH)CO₂R (II) in which R has the same meaning as in formula (I), in a proportion especially of from 0.1 to 1 part by weight per 100 parts by weight of the mixture AL₂+AL₃+AL₄.

It may also comprise oligomers of higher molecular masses, i.e. polyalkyl lactyllactates in which n>4, in a proportion especially of from 0.1 to 4 parts by weight per 100 parts by weight of the mixture AL₂+AL₃+AL₄.

The composition of the present invention may be obtained by quantitative esterification of a preconcentrated commercial lactic acid solution, said quantitative conversion being obtained by removing the water formed by azeotropic distillation.

By way of illustration of commercial lactic acid solutions that may be used according to the present invention, mention will be made of commercial solutions containing 50%, 80%, 88% or 90% solids, it being understood that such solutions are in fact mixtures of water, lactic acid monomer, dimer and oligomers.

Concentration of the commercial lactic acid solutions may be achieved by simple evaporation in one or more steps, at a temperature ranging from 100° C. to 170° C., at atmospheric pressure or under reduced pressure, until a lactic acid composition having a desired total lactic acid content—LAT—is obtained. The LAT corresponds to the mass of lactic acid monomer contained in 100 g of the lactic acid composition.

This mass is determined after saponification at given weight (0.1 to 0.3 g) of the oligomer composition. After neutralizing the reaction mixture, it is analyzed by high-performance liquid chromatography (HPLC) with refractometric detection. This analysis may be performed on a cation-exchange column of “Shodex SH 1011” type using N/100 sulfuric acid as eluent. This technique makes it possible to determine the mass of lactic acid monomer contained in the test sample and, by simple calculation, the LAT.

The concentration reaction is monitored by measuring the weight of water removed and by the amount of water in the concentrate, determined by the Karl Fischer water assay method.

The esterification is performed conventionally in the presence of an acid catalyst chosen in particular from the group comprising sulfuric acid, phosphoric acid, para-toluenesulfonic acid, methanesulfonic acid and acidic resins, for instance Amberlyst A15.

The removal of the water is performed by azeotropic distillation. By way of illustration of azeotropic entrainers that may be used according to the present invention, mention will be made of cyclohexane and toluene.

Cyclohexane will preferably be used.

The quantitative esterification of the concentrated lactic acid solution is performed at temperatures of between 70° C. and 100° C. at atmospheric pressure and with an alcohol/lactic acid molar ratio ranging from 1.3 to 2.

Once the reaction is complete, the reaction medium is subjected to a basic treatment in order to neutralize the acid catalyst.

This treatment is preferably performed on a bed of basic resin, such as on Amberlyst A21 resin, the resin bed being washed with a solvent such as an alkyl lactate.

Concentration by distillation under reduced pressure is then performed so as to remove all the alkyl lactate originating firstly from the esterification reaction and secondly from the washing of the resin.

The products of the composition according to the invention were identified by gas chromatography (GC) coupled to a mass spectrometer.

The composition of the invention may also be obtained from an alkyl lactate of formula (II) by transesterification in the presence of a catalyst chosen from alkyl orthotitanates such as ethyl orthotitanate, zirconium acetylacetonate, tributyltin and strong bases such as KOH, NaOH and quaternary ammonium hydroxides. In order to displace the equilibrium of the reaction below: 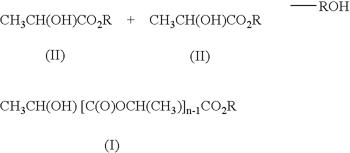
the alcohol coproduced is removed.

The reaction medium is processed in a known manner in order to remove the catalyst used. The reaction medium is then concentrated under reduced pressure so as to remove the unconverted alkyl lactate.

The composition of the present invention is a colorless, odorless liquid with a flash point of greater than 100° C.

It may be used alone or in combination with other solvents, as a cleaning and/or degreasing agent, especially for metallic components.

The examples that follow illustrate the invention.

### EXAMPLES

Preparation of a Composition of Monoethyl and Polyethyl Lactyllactate by Quantitative Esterification of a Preconcentrated Lactic Acid

Production of a Concentrated Lactic Acid

Reagent Used:

A commercial lactic acid composition with a total lactic acid content—LAT—of 88.7 and a free water content of 13.3% is used.

The LAT corresponds to the mass of lactic acid monomer contained in 100 g of lactic acid composition.

The LAT is determined as described previously.

Procedure:

The commercial lactic acid is concentrated until a desired LAT is obtained. To do this, the commercial lactic acid composition to be concentrated is introduced into a rotary evaporator and the water is then removed under 100 mbar at a temperature ranging from 60° C. to 130° C. The reaction is followed by measuring the amount of water removed and by the percentage of water in the concentrate, determined by the Karl Fischer method.

The LAT is measured as described previously.

### Example 1

The following ingredients:
100 g of concentrated lactic acid obtained according to the procedure described previously and having an LAT of 101.6 and a weight content of free water equal to 8%;
75 g of ethanol,
75 g of cyclohexane,
0.3 g of 96% sulfuric acid,
   are introduced into a 250 ml reactor equipped with a thermostatically regulated heating system and a temperature measuring system, and connected to a 10-theoretical-plate adiabatic distillation column connected to a variable reflux column head.

The condensates at the column head are partially conveyed into the distillation column and partially into a decanter. The light decantation phase is recycled into the boiling vessel, and the heavy phase is removed.

The degree of reflux is maintained so as to distil off the cyclohexane/methanol/water ternary azeotrope (75.5%/19.7%/4.8%), the boiling point of which is 61.2° C. Care is taken throughout the reaction not to exceed this temperature at the column head by more than 0.3 to 0.4° C. To do this, the degree of reflux will be adjusted in the course of the manipulation.

123 g of aqueous phase containing 18% water are removed. To compensate for the loss of ethanol in the heavy phase, during the reaction, 80 g of ethanol are gradually introduced into the boiling vessel, using a pump.

The reaction is monitored by assaying, on successive samples taken from the boiling vessel:
water assay by the Karl Fischer method,
assay of the acidity in the boiling vessel.

The reaction lasts about 3 hours 30 minutes.

The end-of-reaction criterion is as follows: % H⁺ (expressed as lactic acid)<0.5%.

The medium is cooled and the reaction mixture is treated with 10 g of a strong basic resin of the Amberlyst A21 type, which is rinsed with 10 g of ethyl lactate.

The medium is then concentrated on a rotary evaporator and the ethyl lactate is removed by distillation under reduced pressure (10 mbar) on the column already described. The end-of-distillation criterion is the temperature of the boiling vessel being less than or equal to 120° C. 74.2 g of ethyl lactate are distilled off. 59 g of a liquid are recovered in the boiling vessel, this liquid being composed of:
44.25 g of ethyl lactyllactate EL₂,
12.98 g of ethyl dilactyllactate EL₃,
1.475 g of ethyl trilactyllactate EL₄ and
0.295 g of ethyl lactate (EL)
−% H⁺=0.03% (expressed as lactic acid),
flash point: 103° C.

The ethyl lactate oligomer composition is determined by GC:
Chromatograph: HP 5890
CP WAX 52 column (50 m*0.53/2 μm)
Vector gas: Helium 6 ml/min
Injector: 200° C.
Detector: 280° C. μTCD
Oven program: 50° C. for 3 min
Gradient: 15° C./min up to 240° C.
Retention time:
   EL: 11.25 min
   EL₂: 15.2 min
   EL₃: 21.1 min
   EL₄: 26.7 min

The products were identified by chromatography coupled to a mass spectrometer.

### Example 2

Same reaction, but 100 g of concentrated lactic acid with an LAT of 107.4% and having a titer of 3% free water, assayed by the Karl Fischer method, are charged.

85 g of heavy phase are removed.

The loss of ethanol is compensated for by gradual addition of 60 g of ethanol. After treating with Amberlyst A15 resin and distilling of the ethyl lactate (31 g), 96 g of a colorless liquid are obtained, this liquid being composed of:
38.016 g of EL₂,
43.20 g of EL₃,
14.40 g of EL₄ and
0.384 g of ethyl lactate,
−% H⁺=0.03% (expressed as lactic acid).

### Example 3

Identical to Example 1, but the sulfuric acid is replaced with 6 g of Amberlyst A15. The reaction time is 4 hours.

Preparation of a Composition of Monoethyl and Polyethyl Lactyllactate by Transesterification:

100 g of commercial ethyl lactate and 5 g of ethyl orthotitanate Ti(OC₂H₅)₄ are charged into a 300 ml reactor equipped with a Vigreux column.

The mixture is brought to reflux under atmospheric pressure and the ethanol released is gradually distilled off, i.e. 17.3 g in three hours.

The reaction mixture is allowed to cool and is treated with distilled water: the orthotitanate precipitates out in the form of a fine solid, which is removed by centrifugation. The remaining ethanol is then distilled off, followed by the unconverted ethyl lactate (under 10 mbar). 37 g of a colorless liquid are obtained in the boiling vessel, this liquid being composed of:
29.97 g of EL₂,
6.475 g of EL₃,
0.37 g of EL₄ and
0.185 g of ethyl lactate,
−% H⁺=not assayable.

Evaluation of a Composition According to the Present Invention as a Cleaning and Degreasing Agent:

The mixture below is prepared, consisting of:
50 g of n-butyl butoxypropionate,
50 g of the composition of monoethyl and polyethyl lactyllactate of Example 1.

The efficacy of said mixture to remove 90% of soiling distributed on a square-mesh metallic gauze (8 holes per cm) 5×5 cm from Weber, in the form of a cylinder 20 mm in diameter, the two edges of the generatrix being 0.5 mm apart is determined.

Procedure:

The metallic gauze is cleaned with methylene chloride, taking the precautions required for methylene chloride. The grille is rinsed with the solvent to be evaluated and is then weighed and finally dried. Using a brush, about 2 g (accurately weighed) of a soiling are distributed, this soiling consisting, by weight, of:
28.5% of PlanetElf ACD 32 motor oil,
28.5% of Oleoflux CPO AC pump oil,
14.3% of pink equator grease,
14.3% of Fontainebleau sand,
14.4% of coal dust.

The grille is then dipped into 50 ml of mixture to be evaluated with stirring (500 rpm). A chronometer is simultaneously started.

The grille is lifted out at 1, 3, 5, 7′30, 10, 12′30 and 15 min and is then weighed at time (t) without stopping the chronometer (duration of this manipulation: about 20 seconds).

These measurements are continued at 5-minute intervals until an efficacy of greater than or equal to 90% is obtained, i.e. when 90% of the soiling has been removed (90% efficacy time).

With the mixture described above, the 90% efficacy time is 45 min.

For comparative purposes, the 90% efficacy time for n-butyl butoxypropionate alone (flash point equal to about 40° C.) is 40 min.

1. A composition comprising a mixture of monoalkyl and polyalkyl lactyllactates of formula:
CH₃CH(OH)[C(O)OCH(CH₃)]ₙ₋₁CO₂R (I)
in which R represents an alkyl radical containing a number of carbon atoms ranging from 1 to 4 and n is an integer equal to 2, 3 or 4.

2. The composition as claimed in claim 1, characterized in that the alkyl radical is a methyl, ethyl, isopropyl or n-butyl radical.

3. The composition as claimed in claim 2, characterized in that the alkyl radical is an ethyl radical.

4. The composition as claimed in claim 1 comprising 100 parts by weight of:
35 to 85 parts by weight of alkyl lactyllactate;
10 to 60 parts by weight of alkyl dilactyllactate; and
1 to 20 parts by weight of alkyl trilactyllactate.

5. The composition as claimed in claim 1, further comprising an alkyl lactate of formula CH₃CH(OH)CO₂R (II) in which R represents an alkyl radical containing a number of carbon atoms ranging from 1 to 4, in a proportion of from 0.1 to 1 part by weight per 100 parts by weight of said composition.

6. The composition as claimed in claim 4, further comprising polyalkyl lactyllactates of formula:
CH₃CH(OH)[C(O)OCH(CH₃)]ₙ₋₁CO₂R
in which R represents an alkyl radical containing a number of carbon atoms ranging from 1 to 4 and in which n is greater than 4, in a proportion of from 0.1 to 4 parts by weight per 100 parts by weight of said composition.

7. The use of a composition as claimed in claim 1 as an agent for cleaning and/or degreasing metallic components.

8. The use of a composition as claimed in claim 1, in combination with at least one solvent, as an agent for cleaning and/or degreasing metallic components.

9. The use as claimed in claim 8, characterized in that the solvent is n-butyl butoxypropionate.
